(19) United States
(12) Patent Application Publication
(10) Pub. No.: US 2003/0084103 A1
(43) Pub. Date: May 1, 2003

(54) Method and system for third-party initiation of an anonymous tele-chat session

(75) Inventors: Moshe Weiner, Kiryat Savionim Yehud (IL); Bat Chen Stilmann-Hirsch, Tel Aviv (IL)

Correspondence Address: SUGHRUE, MION, ZINN, MACPEAK & SEAS, PLLC, 2100 Pennsylvania Avenue, N.W., Washington, DC, 20037-3213, US

(73) Assignee: COMVERSE, LTD.

(21) Appl. No.: 09/984,250

(22) Filed: Oct. 29, 2001

(51) Int. Cl. G06F 15/16

(52) U.S. Cl. 709/205; 709/227

(57) ABSTRACT

A system and method that provides user and third party initiated, anonymous tele-chat sessions. In one embodiment, third party initiation of a tele-chat session is provided by matching a new or initiating user with existing system users. A list of matching users may then be formatted as, for example, a short message service (SMS) or audio message and communicated to the new user. In another embodiment, a user initiates a tele-chat session by establishing a communication link between the tele-chat system and a new user's SMS enabled device. The new user then communicates a message to the tele-chat system, indicating the nickname of an existing user's with which the new user desires a tele-chat session. Once the tele-chat system receives this message, the system identifies the destination user's address. The new user's message then may be communicated to the existing user, without revealing the true identify of either of the users.

### BACKGROUND OF THE INVENTION

1. Field of the Invention

The present invention relates generally to a system that provides anonymous user communication, and in particular to a system that provides anonymous user communication via devices such as telephones, wireless devices, short messages systems, multi-media messages systems, or even network interfaces where either a user or a third party initiates the communication.

2. Description of the Related Art

Many known communication systems permit users to engage in various types of user chat sessions. These systems typically allow users to engage in chat sessions using a variety of devices, such as telephones, wireless devices, as well as network based interfaces (e.g., Web page browsers). However, current systems are deficient since they are only able to provide a limited amount of confidentiality to the system users.

Traditional systems typically utilize a chat room based model where system users gather and engage in chat sessions. Some of the current systems define user chat rooms based on some type of system generated parameters, while other systems permit users to select a particular chat room from a set of predefined chat rooms (e.g., teen room, football room, adult room, etc.) In either system, once a particular chat room has been identified, a user is typically permitted to chat with other system users by utilizing some type of identifiable nickname. One limitation present in these systems relates to a user's lack of flexibility of when and where a chat session may occur. For example, since the user must enter or otherwise utilize a chat room to engage in a chat session, the user's ability to engage in chats outside of a chat room forum is not always available.

Although some systems permit users to chat outside of the chat room environment, these systems typically require the user to provide some type of identifying information to the other users. For example, users desiring a chat session may be required to exchange contact information, such as telephone numbers or email addresses. After doing so, these users typically engage in a chat session utilizing the exchange contact information. This approach is not always desirable because the users are forced to reveal some type of identifying information, foregoing their anonymity.

Some of the known telephone based systems attempt to provide users with some level of confidentiality during a chat session. For example, in an attempt to maintain the identity of each party confidential, some systems provide a connection between the two parties. In some of these systems, users must provide a “match code” after calling a centralized system in order to be connected and engage in chat session with other users. These types of systems allow a user to call a tele-chat server to obtain a nick name or a chat number, which can be called with a pre-defined translation between letters to numbers e.g. the letter ‘b’ could be translated to the number 2 and the letter ‘t’ could be translated to 8 etc. With this translation scheme, a user is able to call another user using the translated chat number, which is usually valid for a limited period of time, and which can be obtained from the user that owns the number or, in some cases, by the tele-chat server.

Other variations of the telephone based systems utilize a computer network in an attempt to provide anonymous communications. These systems further provide a Web site chat room environment where a user may initiate a chat session by connecting to a telephone company's Web site and providing the necessary information (i.e., the initiating user's telephone number and a selected participant). The system then connects the initiating and selected participants without sharing their respective telephone numbers. Although the telephone based chat systems attempt to provide some level of user confidentially, several disadvantages are present in these systems.

For example, users desiring a chat session must depend upon other users calling a centralized system before a chat session may take place. t An additional drawback of these and other systems is that only the system operator (e.g., phone carrier), as opposed to the actual user, may establish and modify a user's nickname. As such, traditional users are unable to easily change their nicknames once it has been provided to the system. Such a system is http://www.amigochat.com/.

### SUMMARY OF THE INVENTION

In view of the foregoing, in accordance with one aspect of the present invention, a tele-chat system initiates a tele-chat session between two or more users. To accomplish this, the tele-chat system performs a matching process that includes matching a new user with existing users to produce a list of matching users, based on the new user's matching criteria obtained during the user registration process. The system also formats a list of matching users into an appropriate message so that it may be processed by an appropriate interfacing device utilized by a receiving user (e.g., the new user). The system then may initiate a tele-chat session by communicating the list of matching users to an appropriate device associated with the new user.

In accordance with this and other aspects of the present invention, the tele-chat session may include a Short Message Service (SMS) and/or a telephone tele-chat session.

In accordance with one aspect of the present invention, the tele-chat system may obtain the new user's matching criteria during a user registration process. The new user's matching criteria may comprise information parameters, such as the new user's interests, hobbies, a particular location, a time, a date, a gender, and a profession.

In accordance with another aspect of the present invention, the new user's matching criteria may further include a matching percentage that defines a number of information parameters which triggers a match. The new user's matching criteria may further include a desired matching parameter that defines which information parameters must be present in order to trigger a match.

In accordance with another aspect of the present invention, user information also may be obtained during the user registration process. User information may include information such as the new user's nickname, actual name, address, phone number, pager number, email address, SMS device number, credit card number, checking account number, and billing information.

In accordance with yet another aspect of the present invention, an interfacing device is utilized during the user registration process. The variety of different types of interfacing devices that may be utilized include, for example, a Short Message Service (SMS) enabled device, a Wireless Application Protocol (WAP) enabled device, a wireless telephone, a wired telephone, and a browser.

In accordance with another aspect of the present invention, the new user and/or tele-chat system administrator provides information during the user registration process.

In accordance with yet another aspect of the present invention, the tele-chat system initiates a tele-chat session after the system has been notified that the new user is available to receive a list of matching users.

In accordance with still yet another aspect of the present invention, a tele-chat session between a new user and a destination user is facilitated by the tele-chat system. The system may facilitate a tele-chat session by establishing a communication link between the tele-chat system and a new user's interfacing device. At some point, the tele-chat system receives a message communicated by the new user, which may contain information such as the destination user's nickname. The tele-chat system then may utilize the destination user's nickname to identify the destination user's address based on this nickname. The new user's message then may be communicated to the destination user based on the destination user's address. User anonymity may be achieved by not providing the new user with the destination user's address. In accordance with other aspects of the present invention, a new user and a destination user utilize different types of interfacing devices during the tele-chat session. The system also may provide a translating process where a message received from a new user utilizing one type of interfacing device is translated into a format that can be processed by the destination user's interfacing device.

In accordance with another embodiment of the present invention, a new user initiates a tele-chat session between that user and at least one other user. In this embodiment, a communication link may be established between the tele-chat system and the new user's interfacing device. Once the communication link is established, the new user may communicate a message containing the destination user's nickname to the tele-chat system. The destination user's address then may be identified based on the destination user's nickname. The tele-chat system then may communicate the new user's message to the destination user. User anonymity may be achieved by not providing the new user with the destination user's address.

These and other aspects, features and advantages of the present invention will become more apparent upon consideration of the following description of the preferred embodiments of the present invention taken in conjunction with the accompanying drawings.

### BRIEF DESCRIPTION OF THE DRAWINGS

FIG. 1 is a block diagram illustrating an overview of a tele-chat system and the relative relationship among several of the major modules comprising this system;

FIG. 2 is a block diagram illustrating an exemplary configuration of a tele-chat session between two users utilizing the same device type;

FIG. 3 is a block diagram illustrating an exemplary configuration of a tele-chat session between two users utilizing different device types;

FIG. 4 is a flowchart illustrating an exemplary method for a third-party initiated tele-chat session; and

FIG. 5 is a flowchart illustrating an exemplary method for a user initiated tele-chat session.

### DETAILED DESCRIPTION OF THE PREFERRED EMBODIMENTS

In the following description of a preferred embodiment, reference is made to the accompanying drawings, which form a part hereof, and which show by way of illustration a specific embodiment of the invention. It is to be understood by those of working skill in this technological field that other embodiments may be utilized, and structural as well as procedural changes may be made without departing from the scope of the present invention.

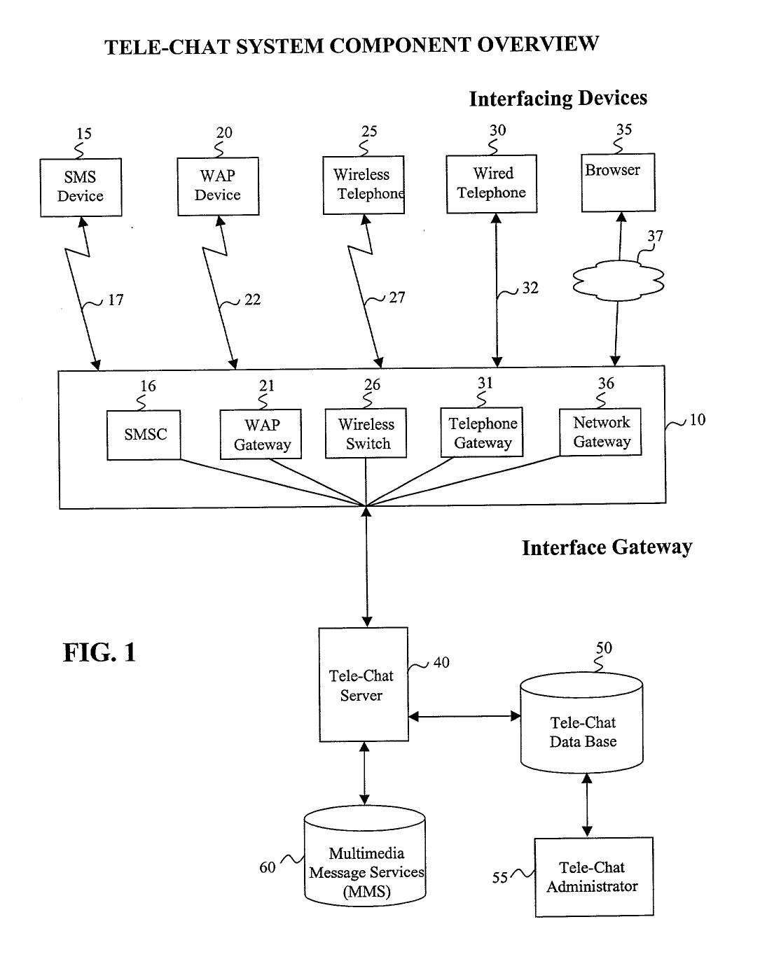

FIG. 1 provides an overview of an anonymous tele-chat system, along with the relative relationship among several of the major modules comprising this system. Several examples of the various types of user interfaces that may be utilized in the present invention are shown in communication with an interface gateway 10. More specifically, an SMS device 15, WAP device 20, wireless telephone 25, wired telephone 30, and a browser 35, are shown in communication with interface gateway 10. Although only a single device of each of the user interfaces is shown (i.e., SMS device 15, WAP device 20, etc.), one of ordinary skill will understand that the tele-chat system may be configured with a plurality of user interfaces (e.g., a plurality of wireless telephones 25). However, for clarity, additional user interfaces have been omitted from this figure.

In the illustrated configuration, each of the user interfaces is shown in communication with tele-chat server 40. Also shown is a tele-chat data base 50 which provides the necessary storage for data that may be utilized to facilitate a tele-chat session. A tele-chat administrator 55, as well as multimedia message services (MMS) 60, are also shown in communication with the tele-chat server 40. Each of the exemplary user interfaces, and their respective communication links, will now be described.

SMS device 15 represents any of the known wireless devices that may be configured to communicate and/or receive SMS text-based messages. Typical SMS enabled devices include cellular phones, pagers, and Personal Digital Assistants (PDAs). The protocol used by SMS device 15 may include any of the known protocols that support SMS messaging. It is known in the art that SMS is a point-to-point or point-to-multipoint service which enables communication of messages (i.e., transmit and/or receive) between communication network users. A typical SMS enabled device permits a user to receive, read, write, edit, save, and send messages. SMS enabled devices typically provide viewing of one or more lines of text on a display panel.

WAP device 20, on the other hand, represents any of the known wireless devices that communicate using a wireless protocol, such as wireless application protocol (WAP). Typical WAP enable devices include cellular phones, pagers, and PDAs. In contrast to SMS enabled devices, WAP enabled devices provide a more robust user interface and are not limited to only displaying text (which is typical of a SMS enabled device). WAP devices typically support Web page browsing and other Web page interactions.

Although several SMS and WAP devices have been described (e.g., mobile telephone, pagers, PDAs, etc.), the present invention is not so limited and may easily be configured to cooperate with most any device that is SMS and/or WAP enabled. Since SMS protocols and messaging standards of SMS enabled devices, as well as the various WAP communication protocols, are known in the art, no further description of these protocols is provided in this specification.

Wireless telephone 25 denotes any of the known communication devices that permit a user to engage in voice communication via a wireless communication link. Similarly to the just-described SMS and WAP devices, wireless phone 25 may be configured as a stand-alone device (e.g., mobile telephone), or may represent a component within another system, such a portable computer or PDA.

In a typical configuration, SMS device 15 is in wireless communication with a Short Message Service Center (SMSC) 16, via wireless link 17 while WAP device 20 is in wireless communication with WAP gateway 21, via wireless link 22. Similarly, wireless telephone 25 is in communication with a wireless switch 26, via telephone link 27. It is to be understood that SMSC 16, WAP gateway 21 may be configured with a wireless switching module (not shown) to facilitate communication between the tele-chat server and the associated wireless devices (e.g., SMS device 15, WAP device 20, etc.) An appropriate switch module may be similar to that used for wireless telephone 25 (e.g., wireless switch 26) as described herein.

Wireless links 17, 22 and 27 may comprise, for example, any of the known wireless communication protocols that support, respectively, SMS messaging, WAP communications, as well as voice and data communications (e.g., GSM, TDMA, CDMA). Although separate wireless links are illustrated for the SMS and WAP devices 15 and 20, as well as wireless telephone 25, it should be understood that a single wireless link capable of communicating WAP and SMS messages, as well as communicating voice and data signals to the wireless phone 25 may be utilized.

SMS message processing at the SMSC 16 may include any of the necessary services to provide message communication to and from SMS device 15. The SMSC 16 also provides message formatting so that a SMS message may be communicated to tele-chat server 40. Likewise, WAP gateway 21 may be configured to provide the necessary services (e.g., message formatting) that facilitate communication to and from WAP device 20. Furthermore, wireless switch 26 provides the necessary processing (e.g., power, signal control, etc.) that enables wireless voice communication. Techniques for SMS message processing at SMSCs, along with WAP message processing at WAP gateways, as well the requirements for wireless voice communication are known in the art, and therefore will not be further described in this specification.

The extendible nature of the present system is illustrated by one aspect of the present invention that provides additional user interfaces, such as a wired telephone 30 and browser 35. For example, FIG. 1 shows wired telephone 30 in communication with a telephone gateway 31, via telephone link 32. Telephone link 32 may utilize a public telephone line, such as a Public Switched Telephone Network (PSTN), which is well known to those skilled in the art.

FIG. 1 also shows browser 35 in communication with network gateway 36, via network link 37. One purpose of browser 35 is to permit a user an appropriate interface to provide the Tele-chat server 40 and/or Tele-chat database 50 with user information. However, it is to be understood that additional methods, such as the Tele-chat administrator 55, or any of the other user interfaces, may be utilized for providing this information. As such, one of ordinary skill will realize that while browser 35 may be utilized in one aspect of the present invention, it is not essential to the operation of the present invention.

Browser 35 may comprise, for example, a computer system or any other device that provides access to Web sites and associated Web pages so that a user may provide information to the tele-chat server 40 and/or tele-chat database 50. More particularly, an appropriate browser 35 device would permit a user to supply or otherwise identify user matching criteria.

Computer systems that are compatible with the present invention include personal computers, server-based workstations, and portable computers. Browser 35 may interact with connected systems (e.g., Web sites, Web pages, tele-chat server 40, tele-chat database 50, etc.) by utilizing, for example, a Web browser (e.g., Netscape™, Internet Explorer™). However, it is to be appreciated that the network interface aspect of the present invention is not limited to Web browsers, and any known device or system that permits a user to supply the tele-chat server 40 and/or tele-chat database 50 with user data is appropriate.

Network link 37 may comprise anything from a local area network (LAN) to a wide area network (WAN), a metropolitan area network (MAN), or the Internet. Communication involving input/output operations with this network may comprise any of the known network application protocols, (e.g., HyperText Transfer Protocol (HTTP), File Transfer Protocol (FTP), Windows Internet Name System (WINS), Simple Mail Transfer Protocol (SMTP), etc.)

Network gateway 36 provides services that are necessary for proper message routing, as well as any necessary message formatting. That is, this gateway may be configured with the necessary software and/or hardware to facilitate communication between the user interface and the tele-chat server 40. Since gateways that provide these types of services are well known in the art, they will not be further described.

Although FIG. 1 shows the incorporation of each individual gateway interface (e.g., SMSC 16, WAP gateway 21, wireless switch 26, telephone gateway 31, and network gateway 36) into a single interface gateway 10, the present invention is not so limited. Thus, it is to be understood that one or more of the individual gateway interfaces may be implemented as a separate gateway. It should also be understood that interface gateway 10 also may be implemented on the server side of the present invention, and therefore may be integrated with tele-chat server 40.

FIG. 1 also shows tele-chat server 40 in communication with tele-chat database 50, as well as the tele-chat multimedia server (MMS) 60. The MMS 60 may be utilized to provide storage for multimedia data, such as pictures, videos, graphics, texts, sounds, and the like. Access to tele-chat server 40 and tele-chat database 50 may be via one of the user interfaces (e.g., SMS 15, WAP device 20, etc.), or via a tele-chat administrator 55.

A variety of operations provided by the tele-chat system may be generated and controlled by a device, such as the tele-chat server 40. Operations performed by the tele-chat server 40 include a user registration process, a matching function, a routing process, a message format translation process, third party initiation of a tele-chat session, as well as enabling user initiated tele-chat sessions. Although a single tele-chat server 40 is illustrated, it is to be understood that additional tele-chat servers may be utilized as may be required.

User Registration Process

The user registration process relates to operations that may be performed to register and/or obtain information from a user utilizing the tele-chat system. Users of the tele-chat system may enter information during a registration process via any of the user interfaces (e.g. SMS device 15, WAP device 20, wireless phone 25, wired telephone 30, browser 35, etc.) Although the tele-chat system accommodates a variety of user interfaces to accomplish the registration process, the browser 35 interface is particularly helpful since this type of interface typically comprises a robust graphical user interface that facilitates user interaction.

The types of information that a user typically provides during a registration session includes information relating to the user as well as a user's matching criteria. Information relating to the user may include a user's actual name, nickname, addresses, phone numbers, pager numbers, email address, billing information. This information also may include billing information, such as credit card or checking account number so that the system can charge a particular user for system usage. A user's matching criteria typically includes a number of parameters, such as the user's interests or hobbies, a particular location, time, date, gender, and the like. Some or all of the user's matching criteria parameters may be determined by the user or predefined by the tele-chat system.

For example, a user may desire to chat with others who have an interest in snow skiing. In this example, the user may indicate “snow skiing” as a “hobby” parameter. The user also may provide additional parameters which can either broaden or narrow the user's desired match. In the current example, the user could further indicate a particular location (e.g., Lake Tahoe) and date (Jan. 1, 2002) as additional parameters.

The user also may identify a matching percentage as one of the parameters. The user may indicate that a chat session is desired with only those who match all of that user's matching criteria parameters. For example, the user may indicated a desire to chat with those who match that user's hobby, location, and date (i.e., snow skiing, Lake Tahoe, Jan. 1, 2002). On the other hand, the user may wish to broaden the list of matching users by indicating a desire to chat with those who match a certain percentage (or certain parameters) of the user's matching criteria parameters. In this example, a successful match may occur when an existing user has met two of new user's matching criteria parameters. More specifically, a successful match may occur when an existing user has matched the new user's hobby and location parameters (i.e., “snow skiing” and “Lake Tahoe”).

It is to be understood that a user of the tele-chat system may utilize a variety of different methods to provide the tele-chat system with information during a registration session. Typically, the type of interfacing device (e.g., SMS device, telephone, etc.) will dictate the method used to enter this information.

For example, the tele-chat system may permit a user to input information during a registration session via a telephone (e.g., wireless telephone 25, wired telephone 30, etc.) In this configuration, a user may connect to the tele-chat server 40 via wireless telephone 25. The tele-chat system also may be configured with an interactive voice reply (IVR) system which could prompt the user with a series of questions (e.g. favorite hobbies, nationality, dating preferences, etc.) and accept the user's reply. Typical user response methods include pressing a particular keypad number to indicate a response (e.g., press the “1” key to indicate “yes,” press the “2” key to indicate “no”). Since IVR systems are well known in the art and are publicly available, the IVR system will not be further described in the specification.

A user also may engage in a registration session via an SMS or a WAP enabled device. Similarly to the telephone configuration, the SMS/WAP configuration may prompt the user with a series of questions. In response, the user may input the requested information using his/her interfacing device. Again, upon the conclusion of the question and answer session, the tele-chat system may utilize the user's answers to build the user's matching criteria, as well as to identify that user's nickname.

Utilizing a browser 35 interface is an additional method for a user to provide information during a registration session. The browser 35 interface permits a user to communicate with the tele-chat server 40 via a network, such as the Internet. In this example, the user may be provided with an appropriate Web page. The Web pages permits the tele-chat system to present a number of different types of questions, as well as permitting the user to submit any necessary responses. Similarly to the other interfacing devices (e.g., SMS device 15, wireless telephone 25, etc.), the tele-chat system in this configuration may utilize the user's responses to generate the user's matching criteria and nickname.

Still yet another method of conducting a registration session is to utilize a tele-chat administrator 55 to gather or obtain some or all of the necessary information for matching tele-chat users. The tele-chat administrator 55 represents a person, such as an employee of the tele-chat system, who inputs user information into the tele-chat system (e.g., tele-chat server 40, tele-chat database 50, multi-media services (MMS) 60, etc.) The tele-chat administrator 55 may obtain user information from, for example, documents or other materials that a tele-chat user has provided. For example, a user may have previously completed a questionnaire comprised of a variety of questions. The user's response to these questions may be used to generate the user's matching criteria.

The tele-chat system may be configured to permit the tele-chat administrator 55 to enter the user information via any of the interfacing devices (e.g., SMS device 15, WAP device 20, wireless phone 25, wired telephone 30, browser 35, etc.), as well as any other appropriate type of device (e.g., scanner, card reader, computer, etc.) As such, it is to be realized that data regarding a tele-chat user may be provided by the user and/or by a third party such as a tele-chat administrator 55.

The above examples illustrate a variety of different methods for obtaining information during a registration process. Although a few general examples have been provided, one of ordinary skill will realize that the present invention is not so limited and that most any device that permits entry of the necessary information may be utilized. Moreover, the present invention is not limited to the illustrated types of information that may be obtained during a registration process (e.g., a user's matching criteria and user information). Instead, these examples have been provided to illustrate some of the capabilities of the present system.

As noted above, user information that may be obtained during a registration session typically includes a nickname, as well as the users actual name, address, phone numbers, pager numbers, email address, and the like. Utilizing a nickname permits tele-chat system users to engage in a tele-chat session while remaining anonymous. The user may be provided with a nickname generated by the tele-chat system (e.g., “ANON357”), or the user may be given an option to define his/her own nickname (e.g., “Bob123”). The generation of a user nickname typically occurs during a registration process, but may be generated or modified at most any time. This aspect of the present invention permits a user to have some control over the generation and modification of his/her nickname.

Typically, a user will have a single nickname that corresponds to that user's matching criteria. However, the tele-chat system may be configured to permit a user to specify a plurality of nicknames that are each associated with the same matching criteria, or to have a plurality of matching criteria sets relate to a single nickname.

Typically, user matching criteria and other user information is inputted during a registration process that occurs during the user's initial period of usage of the tele-chat system (e.g., the first time the user accesses the system). However, it is to be understood that a user may be provided an opportunity to add, delete, or otherwise modify any or all of the supplied information at most any point. This aspect permits users to modify, for example, their matching parameters as well as their nickname whenever the need arises.

Matching Function

The tele-chat server 40 also may be configured with a matching function that matches users in the tele-chat system based on the user's matching criteria parameters (described above). One aspect of the matching function generates a list of existing users that meet a new user's matching criteria parameters. Existing users refer to tele-chat system users who have provided the system with user matching criteria parameter via a procedure, such as the registration process. A new user is one who has provided matching criteria to the tele-chat system and desires the tele-chat system to generate a matching list of users.

The matching process may be implemented at most any time to accommodate a varying range of requirements. For example, a user may be permitted to trigger a matching process after a user has provided the appropriate amount of data. Alternatively, the tele-chat system may automatically initiate a matching process whenever a new user is added to the system or whenever an existing user modifies his/her existing registration information (e.g., adding an additional matching criteria parameter). The tele-chat system also may be configured so that the generated list of matched users may be stored in the tele-chat database 50, for example, so that this data is available for later use.

Message Routing

The tele-chat server 40 may be further configured with a routing function that facilitates communication between users during a tele-chat session. One aspect of the routing function enables users to remain anonymous during a tele-chat session. In particular, the routing function provides the necessary translation between a user's actual number (e.g., 555-1212) and a user's “nickname” (e.g., Anon357). The present invention also provides for the routing of tele-chat messages exchanged between a variety of different types of interfacing devices (e.g., SMS device 15, WAP device 20, wireless telephone 25, etc.)

Several exemplary methods for providing message routing will now be described. In particular, a description is provided of an exemplary routing process for messages exchanged by SMS enabled devices. However, the present invention is not limited to these devices and methods, and most any of the known message routing techniques may be utilized As one example, the message routing technique may include a website where surfers can obtain a nick-name that each user (e.g., an SMS user) can use to send/receive messages without being identified. It is to be further understood that since each of the interfacing devices utilizes a general routing process, the routing process described in reference to SMS enabled devices may be used to provide message routing for any of the other interfacing devices.

In situations where users are engaging in a tele-chat session utilizing SMS enabled devices, a sending user may send an SMS message to a destination user, via the tele-chat server 40. A typical SMS message utilized by the present invention is formatted with a header portion and a content portion.

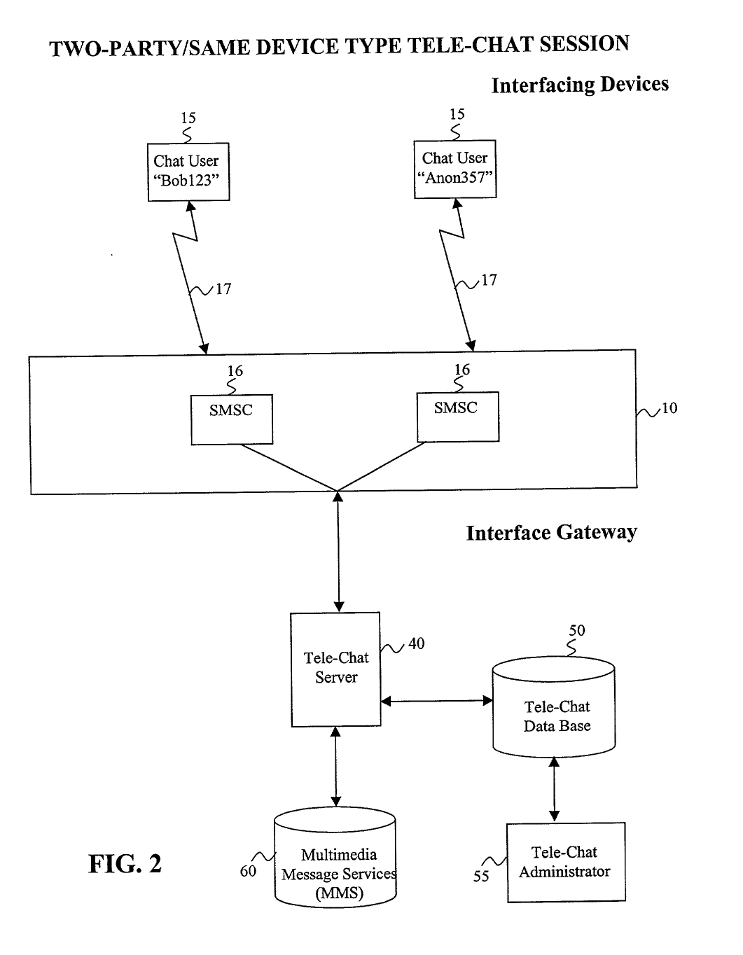

To illustrate this routing process, a tele-chat session between SMS device users “Anon357” and “Bob123” will be described. An exemplary system configuration of a tele-chat session between two SMS device users is shown in FIG. 2. In this example, “Bob123” is the sending user and “Anon357” is the destination user. An appropriate SMS message format that “Bob123” may communicate to “Anon357” is “*** Anon357***hello there.” In this message, the “Anon357” (header) portion identifies the destination user's nickname, and the “hello there”(content) portion represents the actual message that is communicated to the destination user (“Anon357”). The “***” contained in the exemplary message provides a mechanism for the tele-chat system to segment the different parameters of the SMS message. It is to be realized that the illustrated message is but one example of the type of SMS message formats that may be utilized.

Once the sending user generates a message, it is communicated via the appropriate pathway (e.g., wireless link 17) to the tele-chat server 40. Once the tele-chat system receives the message, the message may be parsed into the appropriate parameters (e.g., nickname and content). The system may then perform the necessary processing to associate the destination users phone number with that user's nickname. Again, the destination user (e.g., “Anon357”) may have provided the system with his/her phone number during a registration session. In the current example, “Anon357” may have provided a pager number, such as 555-1212. Thus, when the system processes the message sent by “Bob123,” the system may associate the pager number 555-1212 with the destination user nickname “Anon357.”

The tele-chat system then may communicate the “hello there” message to the destination user using the destination user's pager number. Specifically, the tele-chat session may communicate the “hello there” message to “Anon357.” By utilizing this method, “Bob123” is able to generate a message on an SMS enabled device and communicate it to another user (“Anon357”). Moreover, “Anon357” is able to receive this message without having to reveal his/her identity to “Bob123” because the tele-chat system provided the necessary nickname/pager number association.

Messages sent from “Anon357” to “Bob123” may be routed by the tele-chat system in manner similarly to the just described “Bob123” to “Anon357” message communication. By utilizing this message exchange method, a tele-chat session may occur between two or more users who may choose to remain anonymous.

Message Data Translation

A tele-chat session may be characterized as an interaction between two or more persons utilizing, for example, an appropriate user interfacing device (e.g. SMS device 15, WAP device 20, wireless telephone 25, wired telephone 30, browser 35, etc.) It is to be understood that a tele-chat session may occur between users utilizing the same type of interfacing devices, as well as between users utilizing different types of interfacing devices. For example, a same type device tele-chat session may occur between users who are both using an SMS enabled device (e.g., SMS device 15) or between users who both are utilizing a telephone (e.g., wireless telephone 25 or telephone 30).

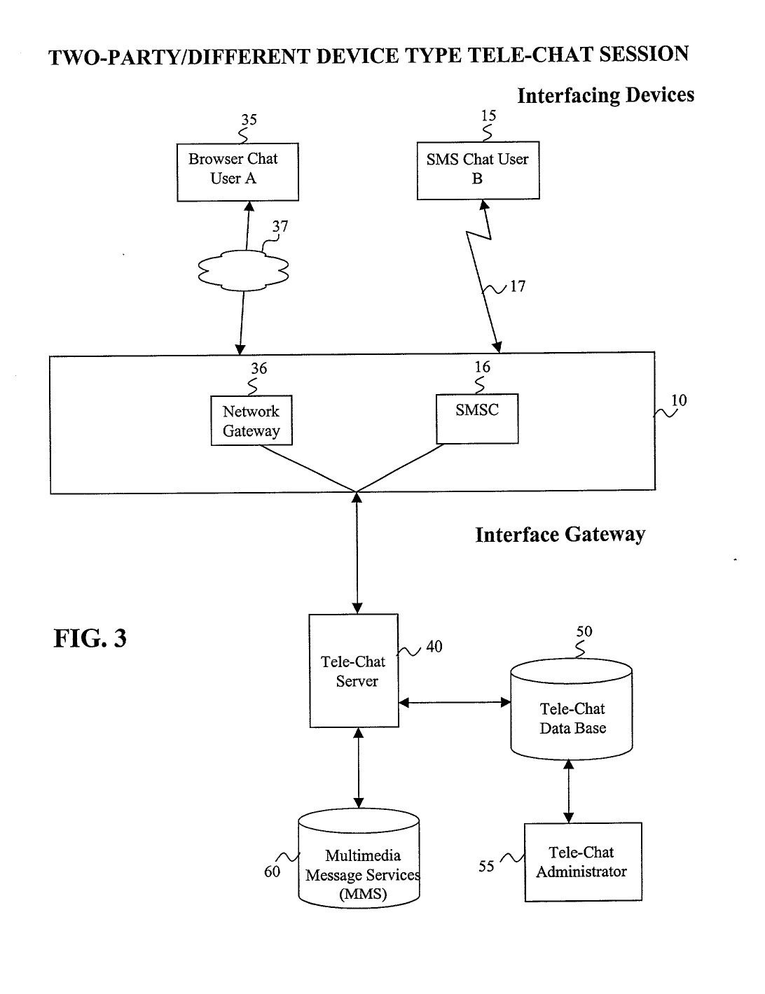

One of the possible combinations of different device type tele-chat sessions supported by the present invention include, for example, browser 35 and any of the other interfacing devices (i.e., SMS device 15, WAP device 20, wireless telephone 25, wired telephone 30). Another example is where a browser user engages in a network based chat (e.g., Internet text-based chat) with a user having an SMS device 15. An exemplary system configuration of this type of tele-chat session is shown in FIG. 3.

In another type of tele-chat situation, a user may utilize a browser to engage in a tele-chat session comprising a voice over IP with a user having a telephone (e.g., wireless telephone 25 or wired telephone 30).

To facilitate communication between users during the tele-chat session, the tele-chat server 40 may be configured to accommodate any data translation requirements. Data translation is typically necessary when users engage in a tele-chat session utilizing different-type interfacing devices. Methods for performing the necessary data conversions between the different type device (e.g., SMS messages to WAP messages, network based chat messages to SMS messages, voice over IP to wireless or fixed line telephone, etc.) are well known in art and are not further described in this specification. As such, one of ordinary skill will clearly realize that the present invention supports most any combination of user interfacing devices to provide a tele-chat session between or among any of a plurality of users.

Third-Party Initiated Tele-Chat Session

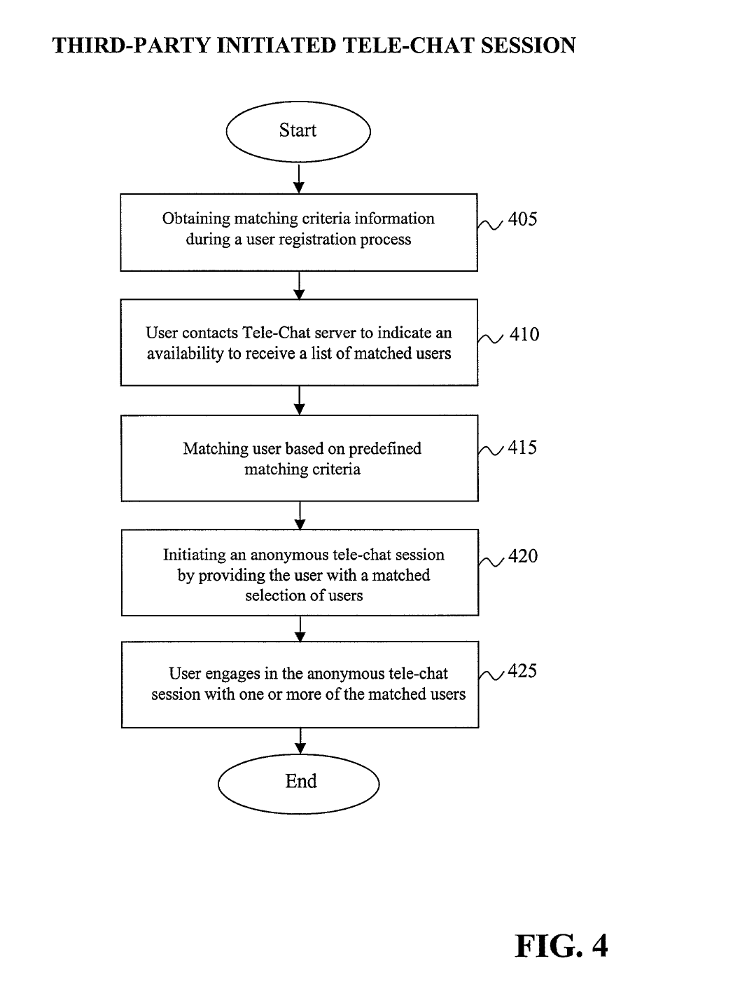

The present invention permits the initiation of a tele-chat session in a variety of different ways. An exemplary tele-chat session, initiated by a third party (i.e., one who is not a participant in a tele-chat session), will now be described with respect to FIG. 4.

A tele-chat session will be described with respect to two users, with reference made to a variety of different interfacing devices. In particular, reference will be made to SMS enabled devices (e.g., pagers, wireless telephones, PDAs, etc.), as well as telephone devices (e.g., wireless telephone 25, wired telephone 30). However it is to be understood that similar methods may be utilized to facilitate a tele-chat session between a plurality of users using most any combination of the previously described interfacing devices (e.g., WAP device 20, browser 35, etc.)

In one embodiment of the present invention, a registration process may be performed to obtain a user's matching criteria information (operation 405). As previously described, the matching criteria information may include data such as the user's interests, hobbies, profession, gender, and the like. In another operation, the user contacts the tele-chat system (e.g., tele-chat server 40) to indicate that the user is available to receive a list of those who meet the user's matching criteria (operation 410).

The tele-chat system then may perform a matching process where the system determines whether any matches exist between the user and existing users in the tele-chat system (operation 415). During the matching process, the tele-chat system may utilize information obtained during the registration process to determine if a match has occurred.

In the next operation, the tele-chat system initiates a tele-chat session by providing the new user with a list of existing users who matched the new user's matching criteria (operation 420). Again, it is to be understood that the existing users will typically have provided matching criteria data to the tele-chat system at some point prior to the just-described matching process.

During operation 420, the matched user, or list of users, may be notified that a match has occurred. The tele-chat server 40 may then notify the users in a number of different ways. For example, each of the matched users may be sent an SMS message indicating that a match has occurred. Alternatively, for telephone users, notification may utilize some type of audio message that contains an audible message containing the list of the matched users.

The information provided in the notification (e.g., SMS message, audio message) may include any information regarding the matched users, such as the user's actual name, nickname, address, user interface number, phone numbers, pager numbers, email address, etc. This information also may include any of the user's matching criteria (e.g., common interests, hobbies, location, time, date, gender, etc.) However, the present invention is not so limited and may be configured to provide as much, or as little, information that is necessary to permit users to engage in a tele-chat session.

For example, in accordance with another aspect of the present invention, the tele-chat system may be configured to provide anonymous tele-chat sessions where only the matched user's nickname (e.g., “Bob123”, “Anon357”, “CTM867”, etc.) is supplied to the other users.

Once the new user receives the information, the matched users may engage in a tele-chat session utilizing their respective user interfacing devices (e.g., SMS device 15, WAP device 20, wireless phone 25, etc.) (operation 425). More specifically, as described earlier, matched users may exchange SMS or telephone generated messages. According to one possible embodiment, after the system identifies (at least) two users with matching criteria(s) it approaches the matched users in order to enable them to initiate an (anonymous) chat. . Of course, if the system initiates the chat, one or more of the users can refuse to chat at that time). In another example, the system provides user A with user's B nick name or ‘nick phone’ after the system determines that user B's criteria matches that of user A. In this particular example, the system lets the user(s) initiate the chat, rather than initiating the chat itself. In case user A is an SMS user, user A can send an SMS message to a number, such as, 123456#88990 where 12345 is the tele-chat server's number and 88990 is the ‘nick phone’ No. of user B in order to initiate the chat. This message exchange may continue for a period of time until any of the users decide to terminate the tele-chat session. However, the tele-chat system may be configured so that the tele-chat system triggers a tele-chat session termination (e.g., user time limit).

Although operations 405 through 415 have been described in a particular order, the present invention is not so limited. For example, the matching operation 415 may be performed prior to the user indicating his/her availability to receive matched user information (operation 415). Moreover, the tele-chat system may be configured to provide a user with matched user information (operation 420) at predetermined times (e.g., every hour, during the user's workday, etc.)

User Initiated Tele-Chat Session

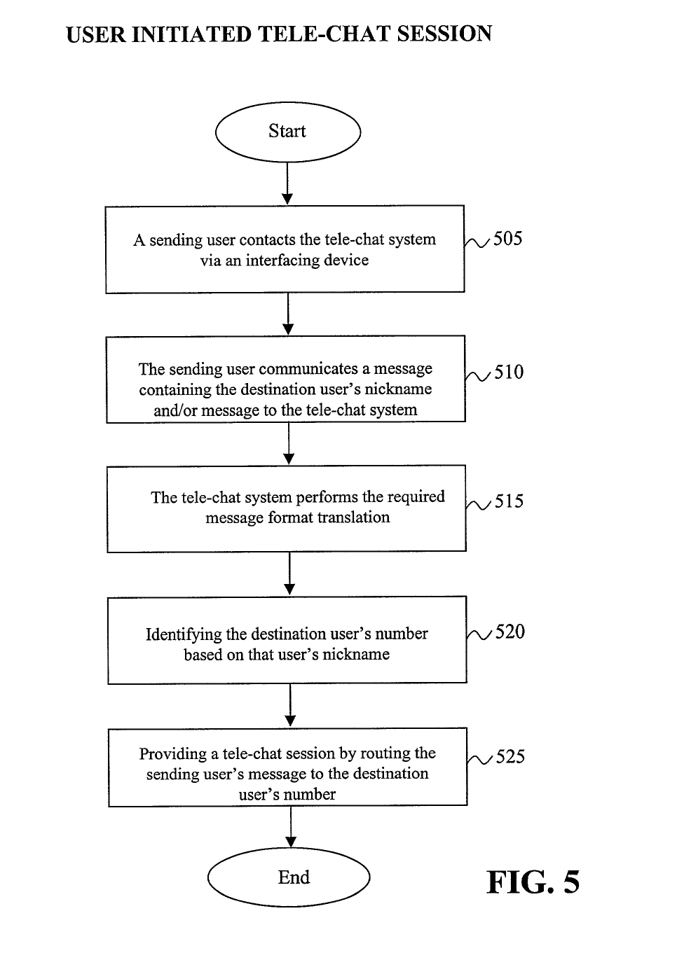

In addition to the just described, third-party initiated tele-chat session, the present invention may be configured to provide user initiated tele-chat sessions. In this alternative embodiment, a user initiates a tele-chat session. An exemplary, user initiated tele-chat session will now be described with respect to FIG. 5.

Similarly to the third party initiated tele-chat session embodiment, a user initiated tele-chat session will be described with respect to two users, with reference made to a variety of different interfacing devices. As such, it is to be understood that the method show in FIG. 5 may be used to conduct a tele-chat session between two or more users using most any combination of the previously described interfacing devices (e.g., SMS devices 15, WAP devices 20, browser 35, etc.) It should also be understood that the method illustrated in FIG. 5 does not require that the tele-chat system provide a matching process or even provide the sending user with the nickname of a destination user (as described in FIG. 4). However, any of these aspects may easily be incorporated into the user initiated tele-chat session embodiment.

The method shown in FIG. 5 requires the sending user to have at least some knowledge of the destination user's nickname. This knowledge may be obtained from any of a variety of sources. For example, the sending user may have learned of the destination user's nickname during a previous tele-chat session. Alternatively, the destination user's nickname may have been published in some form (e.g., book, magazine, newspaper, Web page, bulletin board, etc.)

In any event, the sending user may have a desire to engage in a tele-chat session with a destination user. To accomplish this, the sending user contacts the tele-chat system via one of the appropriate interfacing devices (operation 505).

Next, the sending user communicates a message to the tele-chat server 40 (operation 510). If the user is using an SMS enabled device, this communication may be an appropriately formatted SMS message. As previously noted, the communicated message may contain data, such as the destination user's nickname as well as the sending user's message (e.g., “***Anon357***hello there”).

On the other hand, if a telephone is used, the tele-chat system may prompt the sending user for information (e.g., the destination user's nickname). As previously discussed, a user may be prompted by a system, such as an interactive voice reply (IVR) system. The sending user may then communicate a message by responding to the IVR system (e.g., press “1” to chat with “Anon357”, press “2” to chat with “CTM867”, etc.) Another method of identifying a destination user's nickname is for the sending user to enter the nickname via a telephone's alphanumeric keypad (e.g., “Anon357, “555-1212”, etc.) Regardless of which method or device is used, a message containing the destination user's nickname, and possibly even a message, is communicated to the tele-chat server 40.

In the next operation, the tele-chat system may perform any required message format translation (operation 515). Again, message format translation is typically necessary whenever users engage in a tele-chat session utilizing different interfacing device types (e.g., the sending user uses a browser and a destination user uses an SMS enabled pager).

Next, the destination user's number is identified based on that user's previously supplied nickname (operation 520). In the current example, “Anon357” previously provided the tele-chat system pager number “555-1212.” The system then may route the sending user's message to the destination user, which in the current example results in the tele-chat system communicating a message to pager number 555-1212. More particularly, the message “hello there” is communicated to “Anon357” at pager number 555-1212. At this point, one instance of a tele-chat session is completed.

In contrast, such as in situations where telephone interfaces are used, the tele-chat system may be configured to provide a phone line connection between the sending user and the destination users. In this configuration, once the destination user answers the phone, the two users may engage in a conversation (i.e., a tele-chat session). In the current example, the sending user would engage in a tele-chat session with “Anon357” user. It is to be understood that this tele-chat session may occur even though the sending user does not know “Anon357's” pager number because of the tele-chat system's ability to provide anonymous tele-chat sessions.

While the invention has been described in detail with reference to disclosed embodiments, various modifications within the scope and spirit of the invention will be apparent to those of working skill in this technological field. Therefore, the invention properly is to be construed with reference to the appended claims.

What is claimed is:

1. A method for initiation of a tele-chat session, said method comprising:
matching an initiating user with existing users, by utilizing predefined matching criteria associated with said initiating user, to produce a list of matching users; and
communicating information associated with said list of matching users to said initiating user so that said initiating user can initiate a tele-chat session with the matching users.

2. The method according to claim 1, further comprising initiating the tele chat session with the matching users by associating the communicated information about the list of matching users with the addresses of the matching users.

3. The method according to claim 1, method further comprising:
obtaining said initiating user's matching criteria during a user registration process, wherein said initiating user's matching criteria comprises information parameters selected from at least one of the initiating user's interests, hobbies, a location, a time, a date, a gender, and a profession.

4. The method according to claim 2, wherein said initiating user's matching criteria further comprises a matching percentage, wherein said matching percentage defines a number of said information parameters which are to trigger a match during said matching.

5. The method according to claim 2, wherein said initiating user's matching criteria further comprises a desired matching parameter, wherein said desired matching parameter defines which ones of said information parameters must be present in order to trigger a match during said matching.

6. The method according to claim 2, wherein the information associated with said list of matching users that is communicated to said initiating user does not include the addresses of the matched users.

7. The method according to claim 6, wherein said user information comprises information selected from at least one of said initiating user's nickname, actual name, address, phone number, pager number, email address, SMS device number, credit card number, checking account number, and billing information.

8. The method according to claim 1, further comprising:
using an Short Messaging Service (SMS) enabled device during a user registration process.

9. The method according to claim 1, further comprising:
utilizing an interfacing device during a user registration process, wherein said interfacing device comprises a device selected from the group consisting of a Short Message Service (SMS) enabled device, a Wireless Application Protocol (WAP) enabled device, a wireless telephone, a wired telephone, and a browser.

10. The method according to claim 8, wherein a tele-chat system administrator provides information during said user registration process.

11. The method according to claim 1, wherein said tele-chat session is initiated after said initiating user requests said list of matching users.

12. The method according to claim 1, further comprising:
facilitating a tele-chat session between said initiating user and a destination user who is one of said matching users via a Short Message Service (SMS) Message, wherein said facilitating is performed by: establishing a communication link between said tele-chat system and said initiating user's SMS enabled device;
receiving a message communicated by said initiating user, wherein said message comprises said destination user's nickname;
identifying a destination address of said destination user based on said destination user's nickname, wherein said destination user's address is not provided to said initiating user; and
communicating said new user's message to said destination user based on said destination user's address.

13. The method according to claim 12, wherein said initiating user and said destination user utilize different types of interfacing devices during said tele-chat session.

14. The method according to claim 13, further comprising:
translating said received message into a format that can be processed by said destination user's interfacing device.

15. The method according to claim 12, wherein said destination address comprises a pager number of said destination user.

16. The method according to claim 12, wherein said destination address comprises a telephone number of said destination user.

17. The method according to claim 12, wherein said initiating user's message further comprises image data that is viewable on said destination user's interfacing device.

18. A tele-chat system providing third party initiation of a tele-chat session, said system comprising:
a tele-chat server that is in communication with said initiating user, wherein said tele-chat server is configured to initiate a tele-chat session by:
matching said initiating user with existing users to produce a list of matching users, wherein said matching utilizes predefined matching criteria associated with said initiating user; and
communicating information associated with said list of matching users to said initiating user so said initiating user can initiate the telechat session, but without providing the initiating user with the addresses of the matching users

19. The system according to claim 18, said system further comprising:
obtaining said initiating user's matching criteria during a user registration process.

20. The system according to claim 19, wherein said initiating user's matching criteria comprises information parameters selected from the group consisting of said initiating user's interests, hobbies, location, a time, a date, a gender, and a profession.

21. The system according to claim 20, wherein said initiating user's matching criteria further comprises a matching percentage, wherein said matching percentage defines a number of said information parameters which are to trigger a match during said matching.

22. The system according to claim 20, wherein said initiating user's matching criteria further comprises a desired matching parameter, wherein said desired matching parameter defines which ones of said information parameters must be present in order to trigger a match during said matching.

23. The system according to claim 20, said system further comprising:
a registration unit that is in communication with said tele-chat server, wherein said registration unit is configured to obtain information relating to said initiating user during said user registration process.

24. The system according to claim 23, wherein said user information comprises information selected from the group consisting of said initiating user's nickname, actual name, address, phone number, pager number, email address, SMS device number, credit card number, checking account number, and billing information.

25. The system according to claim 18, further comprising:
an interfacing device that is in communication with said tele-chat server, wherein said interfacing device is utilized during a user registration process, and wherein said interfacing device comprises a device selected from the group consisting of a Short Message Service (SMS) enabled device, a Wireless Application Protocol (WAP) enabled device, a wireless telephone, a wired telephone, and a browser.

26. The system according to claim 25, wherein said initiating user provides information during said user registration process.

27. The system according to claim 25, wherein a tele-chat system administrator provides information during said user registration process.

28. The system according to claim 18, wherein said tele-chat system initiates said tele-chat session after being notified that said initiating user is available to receive said list of matching users.

29. The system according to claim 18, wherein said tele-chat session initiation further comprises:
facilitating a tele-chat session between said initiating user and a destination user, who is one of said matching users, by:
establishing a communication link between said tele-chat server and said initiating user;
receiving a message, communicated by said initiating user, including said destination user's nickname;
identifying a destination address of said destination user based on said destination user's nickname, wherein said destination user's address is not provided to said initiating user; and
communicating said initiating user's message to said destination user based on said destination user's address.

30. The system according to claim 29, wherein said initiating user and said destination user utilize different types of interfacing devices during said tele-chat session.

31. The system according to claim 30, said system further comprising:
a translating module in communication with said tele-chat server, wherein said translating module is configured to translate said received message format into a different format that can be processed by said destination user's interfacing device.

32. The system according to claim 29, wherein said destination address comprises a pager number of said destination user.

33. The system according to claim 29, wherein said destination address comprises a telephone number of said destination user.

34. The system according to claim 29, wherein said initiating user's message further comprises image data that is viewable on said destination user's interfacing device.

35. A method for initiation of a telephone tele-chat session, said method comprising:
matching an initiating user with existing users to produce a list of matching users, wherein said matching utilizes predefined matching criteria associated with said initiating user; and
initiating a tele-chat session by communicating said audio message to said initiating user.

36. The method according to claim 35, further comprising:
obtaining said initiating user's matching criteria during a user registration process.

37. The method according to claim 36, wherein said initiating user's matching criteria comprises information parameters selected from the group consisting of said initiating user's interests, hobbies, a particular location, a time, a date, a gender, and a profession.

38. The method according to claim 37, wherein said initiating user's matching criteria further comprises a matching percentage, wherein said matching percentage defines a number of said information parameters which are to trigger a match during said matching.

39. The method according to claim 37, wherein said initiating user's matching criteria further comprises a desired matching parameter that defines which ones of said information parameters must be present in order to trigger a match.

40. The method according to claim 36, said method further comprising:
obtaining r information relating to the initiating user during said user registration process.

41. The method according to claim 40, wherein said user information comprises information selected from the group consisting of said initiating user's nickname, actual name, address, phone number, pager number, email address, SMS device number, credit card number, checking account number, and billing information.

42. The method according to claim 35, further comprising:
utilizing an interfacing device during a user registration process, wherein said interfacing device comprises a device selected from the group consisting of a Short Message Service (SMS) enabled device, a Wireless Application Protocol (WAP) enabled device, a wireless telephone, a wired telephone, and a browser.

43. The method according to claim 42, wherein said initiating user provides information during said user registration process.

44. The method according to claim 42, wherein a tele-chat system administrator provides information during said user registration process.

45. The method according to claim 35, wherein said said tele-chat session is initiated after said initiating user indicates that it is available to receive said list of matching users.

46. The method according to claim 35, further comprising:
facilitating a tele-chat session between said initiating user and destination user, who is one of said matching users, wherein said facilitating is performed by:
establishing a communication link between said tele-chat system and said initiating user's telephone device;
prompting said initiating user to identify a destination user;
receiving a message communicated by said initiating user, wherein said message is used to determine said destination user's nickname;
identifying a destination address of said destination user based on said destination user's nickname, wherein said destination user's address is not provided to said initiating user; and
providing a communicating link between said initiating user and said destination user so that said initiating user and said destination user may engage in a tele-chat session.

47. The method according to claim 46, wherein said initiating user and said destination user utilize different types of interfacing devices during said tele-chat session.

48. The method according to claim 47, further comprising:
translating said received message format into a different format that can be processed by said destination user's interfacing device.

49. The method according to claim 46, wherein said destination address comprises a pager number of said destination user.

50. The method according to claim 46, wherein said destination address comprises a telephone number of said destination user.

51. The method according to claim 46, wherein said initiating user's message further comprises image data that is viewable on said destination user's interfacing device.

52. A method for initiation of a Short Message Service (SMS) tele-chat session, said method comprising:
establishing a communication link between a tele-chat system and an initiating user;
receiving a message communicated by said initiating user, wherein said message comprises a destination user's nickname;
identifying a destination address of said destination user based on said destination user's nickname, ; and
communicating said initiating user's message to said destination user based on said destination user's address without providing said destination user's address to said initiating user.

53. The method according to claim 52, wherein said initiating user and said destination user utilize different types of interfacing devices during said tele-chat session.

54. The method according to claim 53, wherein said destination user utilizes a Wireless Application Protocol (WAP) enabled device.

55. The method according to claim 53, wherein said destination user utilizes a browser.

56. The method according to claim 53, wherein said destination user utilizes a wireless telephone.

57. The method according to claim 53, wherein said destination user utilizes a wired telephone.

58. The method according to claim 53, further comprising:
translating said received message format into a different format that can be processed by said destination user's interfacing device.

59. A method for initiation of a telephone tele-chat session, said method comprising:
establishing a communication link between a tele-chat system and an initiating user;
receiving a message communicated by said initiating user, wherein said message indicates a destination user's nickname;
identifying a destination address of said destination user based on said destination user's nickname, ; and
establishing a communication link between said initiating user and said destination user based on said destination user's address, wherein said communication link allows said initiating user and said destination user to engage in a tele-chat session without providing said destination user's address to said initiating user

60. The method according to claim 59, wherein said initiating user and said destination user utilize different types of interfacing devices during said tele-chat session.

61. The method according to claim 60, wherein said destination user utilizes a Wireless Application Protocol (WAP) enabled device.

62. The method according to claim 60, wherein said destination user utilizes a browser.

63. The method according to claim 60, wherein said destination user utilizes a wireless telephone.

64. The method according to claim 60, wherein said destination user utilizes a wired telephone.
